(19) United States
(12) Patent Application Publication
(10) Pub. No.: US 2002/0120864 A1
(43) Pub. Date: Aug. 29, 2002

(54) Automatable secure submission of confidential user information over a computer network

(76) Inventors: Jackie Zhanhong Wu, Sunnyvale, CA (US); William W. Rose, Saratoga, CA (US); Steven T. Kirsch, Los Altos Hills, CA (US); Satish Natarajan, Santa Clara, CA (US); Russell D. Wyllie, Mountain View, CA (US); Charles Kline, Los Altos, CA (US)

Correspondence Address: GERALD B ROSENBERG, NEW TECH LAW, 285 HAMILTON AVE, SUITE 520, PALO ALTO, CA, 94301, US

(21) Appl. No.: 09/738,474

(22) Filed: Dec. 13, 2000

(51) Int. Cl. H04L 9/32

(52) U.S. Cl. 713/201; 709/217

(57) ABSTRACT

A repository server system supports one-click retrieval of user data over a communications network in fulfillment of the data requirements of a Web page form served to a user computer system by a Web page server. The repository server system includes a data store that stores user data. The repository server system provides the Web page form with a clickable user interface control to the user computer system. The control encompasses a user data request, issuable by the user computer system and that corresponds to the Web page form. The repository server system is responsive to the user data request to provide a user data response, corresponding to the user data request, to the user computer system.

### CROSS-REFERENCE TO RELATED APPLICATIONS

The present application is related to the following Applications, assigned to the Assignee of the present Application, which are incorporated herein by reference:

1) System and Methods for Integration of a Web Site with a Repository Server, Wu et al., Ser. No. ______, filed concurrently herewith;

2) Secure User-Information Repository Server Accessible Through A Communications Network, Wu et al., Ser. No. ______, filed concurrently herewith; and

3) System and Methods for Flexible, Controlled Access to Secure Repository Server Stored Information, Wu et al., Ser. No. ______, filed concurrently herewith.

### BACKGROUND OF THE INVENTION

1. Field of the Invention

The present invention is generally related to public network connected data repository systems used to store user-information and, in particular, to a network-accessible secure repository server system that stores confidential user-information for access by third-parties subject to user and system defined constraints and conditions.

2. Description of the Related Art

The use of the Internet and other public and private networks to transfer confidential user information continues to grow. In particular, business-to-consumer and business-to-business electronic commerce (e-commerce) sites require secure electronic transactions involving confidential user information to complete purchases. Other sites rely on confidential user information to tailor their site appearance and store prior activities for the benefit of individual users. While some information may be stored on the user computer systems in the form of cookies, the typical requirement is for the user to explicitly establish a site account, with a unique site-identity, to store confidential user-information persistently with the site.

With each new site-account established, the user is burdened with the requirement of maintaining a record of the account, managing the stored user information, and handling the status and confirmations of transactions conducted through each account. This typically requires the user to independently remember a unique user name and password for each account, manually update each and every active merchant account with any changes in billing address, shipping address and credit card information, and to individually manage the processes of confirming electronic transactions, receiving transaction receipts, and monitoring the status of transactions not yet delivered.

While the overall burden of managing an individual site-account may not be large, a typical user will often have a relatively large number of such accounts. As a result, the total burden of fully maintaining more than a few accounts becomes rather impractical. Even for businesses needing to maintain accounts with multiple merchant vendors, the individuality of the site-account presentations, modification methods, and information requirements represents a substantial burden.

The nature and effects of this burden have been recognized for some time. A number of potential solutions have been implemented in various manners, though with only marginal success. These solutions are generally categorized as electronic wallets, or data repositories, where the confidential user data is stored locally on the user's own computer system or on a remote, network connected, centralized repository server. Conventional e-wallets, however, have failed to become more than marginally accepted or used for a variety of fundamental reasons.

For example, local e-wallet applications, such as Gator™ (www.gator.com), provides somewhat limited security for user information stored on the user computer system. In operation, the application intercepts URL requests to selected Web pages, typically the order checkout-form pages, of e-commerce sites previously recorded in the application's local repository, which also records the form layout and data requirements of each page. Some layout and requirements analysis may be performed by the application to account for discrepancies and changes in the Web pages with the result that recognizable form fields are filled-in by the application based on the user information stored in the local repository. This analysis capability is typically extended to attempt to identify Web-form pages and then recognize the specific data requirements of these pages.

The ability of e-wallet applications to reliably discern the specific data requirements of different fields on unknown Web-page forms from multiple unknown sites, and even known sites with changed Web-page forms, is lacking. A significant degree of user intervention is required to compensate for unpredictable form identification and data requirement errors. Furthermore, the matching and processing of available user data to the specific data requirements of a Web-page form is also often unreliable, resulting in the potential for user information to be improperly submitted.

Thus, conventional local e-wallet applications have failed to gain acceptance due to a variety of reasons, including limited ability for the user to differentially control access to the user's information, inadequate security protections, inability to access the e-wallet information globally, and too frequent unreliable identification the data requirements and fill-in of particular fields in ever changing Web-page forms.

Conventional remotely located repository applications, such as Microsoft® Passport (www.passport.com), use a network server as a central repository for confidential user information. Other, typically e-commerce servers are required to tightly integrate with the Passport server in order to securely and reliably request and receive confidential user information. The Web-page form owner is therefore required to maintain all form fields in strict conformance with the requirements of the Passport system in order to receive information from the remote repository server. There is also little or no flexibility for the definition and use of form-fields uniquely required, let alone desired, by a particular participating site. Consequently, any participating site must adopt a specific and proprietary coding nomenclature for binding the Passport system to their Web-page form fields. These integration requirements are recognized to be beyond the practical capabilities of non-commercial sites. Further, the inability to define and use unique fields greatly restricts the Passport system from being used by sites with non-generic user data requirements.

The burdensome design, implementation, and management requirements imposed on each participating site, as well as the enforced inflexibility for handling new and unique types of information represents a substantial barrier to more than marginal acceptance of such remote repository systems. While conventional Passport-type systems generally provide much stronger security over confidential user data and, by definition, reliability to fill-in forms, they provide little or insufficient user capabilities to manage user data and differentially control access to that information by participating sites. For these reasons, the Passport system has met with very limited adoption.

A public standard, known as the Electronic Commerce Modeling Language or ECML (www.ecml.org), has been proposed and met with some limited acceptance. This standard, in effect, merely defines a limited set of names for form fields used by merchants to define a credit-card e-commerce transaction. The defined fields allow specification of a shipping address, billing address, receipt address, the essential details of single credit card, and a very small set of order management fields including little more than an order ID field and a transaction complete field. Thus, the field definitions are sufficient for an e-commerce merchant to submit a credit card number for validation with the card issuer's databases. The ECML standard does not, however, provide for any actual implementation. Rather, the ECML field definitions allow e-commerce system vendors to implement their own credit-card validation services with only a potential for interoperability based on the form naming convention. Further, no provision is made for supporting the validation or storage and retrieval of any additional, let alone non-credit-card, information.

Consequently, none of the known repository-based systems are capable of meeting the broad needs of users to store and define access to their user information in a manner that is secure, flexible enough for use among many participating sites, and sufficiently easy to adopt and maintain by both users and the many different types of potential participating sites.

### SUMMARY OF THE INVENTION

Thus, a general purpose of the present invention is to provide for the secure storage of flexibly-defined confidential user information from a remote repository server and selective provision of the information to any site partnered with the remote repository server system subject to flexibly-defined constraints and conditions.

This is achieved in the present invention by establishing a repository server system to store confidential user-information for selective distribution, on behalf of a user to third-party server systems to enable autonomous form data fill-in of named form fields having third-party server defined data formats. A database is utilized to store the confidential user-information data in named data fields. A repository server processor is coupleable to the database to obtain access to the confidential user-information. The processor is also coupleable to a communications network to receive a form data request issued by the third-party server. The form data request includes a predefined selective mapping of named form fields relative to the named data fields. The processor operates over the selective mapping to access the confidential user-information data and produce instances of the confidential user-information data corresponding to the defined data formats of the named form fields. A form data response, then returned to the third-party server system, contains the confidential user-information data corresponding to the defined data formats of the named form fields.

Selective delivery of confidential user-information is also achieved in the present invention by providing a user identification system that establishes secure and selectively controlled release of information associated with a user identification. The repository server system supports secure network communications with a user and with third-party sites remote from the repository server system. The user and third-party sites pre-establish user and third-party accounts with the repository server system, each receiving an identifying reference recognizable by the server system. The request for information received by the repository server system includes the third-party identity reference and is accompanied by the client identity reference. User account data access in response to the received request is first qualified by data access rules established by the user. Depending on these user established data access rules, the repository server system selectively initiates a communications session with the user, in effect, while the received request is pending with the repository server system, to obtain user responses to the request for and approve release of the user-information to the third-party site.

The repository server system can thus support one-click retrieval of user data over a communications network in fulfillment of the data requirements of a Web page form as served to the user computer system. The Web page form is provided with a clickable user interface control which encompasses a user data request, issuable by the user computer system and that corresponds to the Web page form. The repository server system is responsive to the user data request to provide a user data response, corresponding to the user data request, to the user computer system.

An advantage of the present invention is that a flexible profiling system allows the user to define and control any and all particular confidential user-information that can be accessed, altered, and provided to individual partner sites. The partner sites may be further constrained by a repository enforced typing of any partner to further protect against the inappropriate accessing, altering, or provision of confidential user-information to partner sites. Additionally, a system of sub-profiles or related profiles to be established to allow users of designated accounts to access, alter, and use the confidential user-information of a primary account, within profile defined limits established by the owner/user of the primary account. Within this profiling system, transient use accounts can be established to support one-time or time-limited transaction accesses to profile defined confidential user-information.

Another advantage of the present invention is that a requested set of confidential user-information can be provided to a partner site with little or no interaction with the user. A user-interface control, invoked by a single-click user action or autonomously activated by the loading of a Web page, initiates the information request, with pre-qualified confidential user-information then being returned to the partner site. The pre-qualification of confidential user-information is constrained by the profile and partner site typing functions of the present invention. Thus, the pre-qualification of confidential user-information may flexibly release specific confidential user-information automatically or require the user to confirm release of specific confidential user-information received.

A further advantage of the present invention is that relatively little configuration, programming, or management burden is placed on the partner sites in connection with the utilization of the present invention. Integration of the partner sites with the secure information server of the present invention requires, in preferred embodiments, a single, simple post-processing step to process a new or revised Web page. The post-processing provides a user-interface control button coded with the request for the confidential user-information required to fill-in the form presented by the Web page. The Web-page developer need only then place the button on the Web page to complete the integration of that particular page with the repository server system of the present invention. Furthermore, the partner site is not required to change their form processing code and processes in order to integrate with the secure information server of the present invention, which reduces implementation complexity and time.

Still another advantage of the present invention is that a user can securely and reliably fill-in a partner site Web page form with no more than a single mouse click. Once a user has at least indirectly logged onto the information server, a secure, time limited session is established allowing a partner site to request and transparently receive confidential user-information pre-authorized by the user for release to that partner site. A single click can be used, as in the case of a login, to initiate the partner site request. Alternately, a single click may be used to confirm the acceptance of the form as filled-in. No click may be required where the partner site is permitted to autonomously request the fill-in information and where the applicable partner-site profile established by the user does not specify a use-acknowledgment click.

Yet another advantage of the present invention is that the information requests and transfers are routed through the user's computer. Encryption of the information released, as well as all information provided or edited by the user, is therefore enforced by the information server. For transactions between a user and partner site requiring or just desiring user-identity validation, the establishment of the information server account and subsequent authenticating email, postal, encrypted key-card contacts allows authentication of the client-user to the information server. This information may be securely passed directly to the partner site to authenticate a user. Alternately, the information server may provide its own authentication credentials to the partner site as a proxy for the client-user, where present and prior interactions between the information server and client-user are of a sufficient nature to warrant proxy validation.

A still further advantage of the present invention is that all accesses to the information stored in a user account and all requests for and releases of data can be logged and reported to the user by email, post, or through the account directly. Additionally, information provided from a partner as a receipt in connection with some transaction can be captured and stored for the user in the user account. Capture of this information informs the user of the nature of the transaction and, also, the particular profile used and data released in connection with the transaction. The transaction confirmations and the collection of transaction receipts both serve as checks against unadvised and fraudulent use of the confidential user-information.

Still another advantage of the present invention is that it provides a number of security capabilities, some pro-active and others based on usage reports provided to the user. A proactive security measure includes the prevention of identical credit card information being entered in two or more unrelated user accounts existing on the information server. A reporting measure is that all transactions are logged and are available to being viewed. Since the information requests are routed through the user's computer, the IP address and other identifying information may be logged along with the information provided by the partner site. Also, the partner site is preferably required to establish an account with the information server. Thus, the information server may enforce a positive identification of the partner site, optionally including a reverse-DNS match, before any information is released.

### BRIEF DESCRIPTION OF THE DRAWINGS

These and other advantages and features of the present invention will become better understood upon consideration of the following detailed description of the invention when considered in connection with the accompanying drawings, in which like reference numerals designate like parts throughout the figures thereof, and wherein:

FIG. 1 is a block diagram of the network communications system environment that the present invention is preferably directed;

FIG. 2A is a process flow diagram of a preferred method of operation between a partner site, user, and information server system in accordance with a preferred embodiment of the present invention;

FIG. 2B is a representative view of an exemplary partner site form and active button for initiating an information request connection, on behalf of a partner site to an information server system in accordance with a preferred embodiment of the present invention;

FIG. 3 is a block diagram of the processes and procedures implemented by an information server system in a preferred embodiment of the present invention;

FIG. 4 is a process flow diagram of the partner site system request for and receipt of information from an information server system in accordance with a preferred embodiment of the present invention;

FIG. 5 is a process flow diagram of an information server system handling and responding to information requests from a partner site;

FIG. 6 is a process flow diagram detail of the parsing of an information or other request received by an information server system in accordance with a preferred embodiment of the present invention;

FIG. 7 is a process flow diagram showing the preferred post-processing integration of an information server system with a partner-site Web page form; and

FIG. 8 is a process flow diagram showing the preferred pre-processing integration of an information server system with a partner-site receipts posting Web page.

### DETAILED DESCRIPTION OF THE INVENTION

As generally illustrated in FIG. 1, the environment preferably addressed by the present invention includes a typically public-use communications network 12, such as the Internet, that permits a user of a client system 14 to conduct information transactions over the network 12 with any of the partner site servers 16, 18, 20 and an information server system 22. The partner site servers 16, 18, 20 represent any network accessible computer systems that provide or require a login identification by the user, that request form-entry type information, or that may submit information, such as receipts, on behalf of a user to the information server system 22. The partner site servers 16, 18, 20 may be electronic commerce sites, where the user is allowed to order or purchase goods or services. Site-specific Web page forms are presented to the user to obtain identifying information, such as a login name and password, and other transaction-specific information prior to completing a user transaction. Electronic receipts and receipt-type data, generated in connection with an ecommerce transaction or independently generated and supplied, such as in the case of warranty and product registration, and purchase incentive coupons, are preferably received from partner sites.

In accordance with the present invention, the partner site servers 16, 18, 20, present an additional user-interface (UI) control, such as a clickable button, on Web pages to allow a user to initiate the retrieval of confidential user-information desired to complete a specific data-entry form. The UI control may also be used to initiate or cause the submission of receipts or receipt-type data for storage with the information server system for the benefit of the user. Other controls, such as check-boxes, selection lists, and radio buttons, as well as pre-set site and user-specific site configuration options, can be used as alternative interface controls.

In the case of a Web page form, the user activation of a user-interface control, either directly as through a button click or indirectly through the triggering of a pre-set, a request is issued, preferably using an HTTP Get command or alternately a Post command, on behalf of the corresponding partner site server 16, 18, 20 destined for an information server system 22 that includes a processor system 24 that manages and controls access to an information repository 26. When received, the request contains or is accompanied by sufficient information to authenticate the partner site server 16, 18, 20 and the client system 14 to the information server system 22. The request also identifies the information needed to complete the partner site form presented to the user. This identification of the information requested can be an explicit coded listing of the requested information. Alternately, the identifier is an indirect reference, which is processable by the information server system 22, to obtain a corresponding list of the requested information. Preferably, the identifier is constructed as a hybrid, containing explicit data field references for handling dynamic data requirements and a storage reference for data field references that are well anticipated or static. Using the hybrid specification of data references allows the dynamic or run-time complementing and overriding of the static set of data field references.

In each of these cases, each form field is named such that when this requested information is returned to the partner site, each datum returned is named with a corresponding field name which is the partner site form field assigned name, functionally allowing the form to be autonomously filled-in. Consequently, a single button click, which may be implicitly provided where a pre-set is used, is all that is required to complete a form presented by a partner site.

To operate within the preferred embodiments of the present invention, the user is required to initially establish a user-account on the information server system 22. In establishing this account, the user is allowed to select or is assigned a unique user-identifier, such as a username and password. This identifier, potentially further based on an encrypted key token, is used to subsequently identify the user to a partner server system 16, 18, 20 that has established a partner-account with the information server system 22.

As part of creating or later updating the user account, the user is enabled to provide and store confidential user-information, broadly defined as any information that is reasonably personal to the user, such as name, age, shipping, billing, and home addresses, multiple credit card information, social security number, telephone numbers, medical record numbers, personal interests lists, wish lists, receipts, registrations, survey answers, other use data and files, and various user-oriented and partner site-oriented preferences. Preferably, the user is permitted to establish different named profiles and aliases for information subsets stored in the user account. In general, the profiles define particular user-controlled views to the confidential user-information stored in the user-account. For example, different sets of credit card information, shipping addresses, and other relevant information may be directly named or aliased to descriptive names, provided by and easily identified by the user, used to describe general uses, such as business, medical, and personal or particular uses, such as a specific corporate travel account. These named profiles can then be identified or associated for use with other profiles used, for example, to identify specific partner sites and include other confidential user-information, allowing the user to define site-specific and role-based constraints on the information that may be modified or released. Named profiles, such as “login only,” “company purchase plan,” and “games,” may be established for use in constructing other site-specific profiles. Preferences may be stored globally by the information server system 22 for controlling, constraining, and defining the interoperation of the information server system 22 individually with partner site servers 16, 18, 20 and with the user. Overriding preferences may be established in individual profiles for closely controlling, constraining, and defining the interoperation of the information server system 22 with specific partner site servers 16, 18, 20 and the user.

Profiles that establish roles for partner sites that do not then have partner site accounts established may, in preferred implementations, provide for the creation of such accounts. Thus, for example, a restricted access profile created to allow a doctor or laboratory to transfer in and review profile defined medical data also creates an account for the doctor or laboratory if one is not pre-existing. Time-limited accounts established to provide payment to incidental vendors of goods can also be supported by a user's creation of a corresponding time and value limited user profile. Similarly, a profile providing a limited credit-line usage of a parent's credit card, potentially further limited in terms of allowed product-type purchases that can be made, enables the user of the identified child account to access and use the data within the parent account subject to the profile limitations.

Preferably then, each partner site server 16, 18, 20 is also required to establish a partner-account, which is specific to one or more sites, on the information server system 22. The partner-accounts are each assigned a unique identifier, which must be provided with any partner-site information request. The information server system 22 also requires coordinated receipt of the user-identifier. In accordance with the present invention, the user-identifier is independently provided from a client system stored cookie directly to the information server system 22. The user-identifier is not provided to the partner-site. The required independent receipt of both the partner and user-identifiers, which are only commonly known to the information server system 22 provide a significant level of authentication of the partner site servers 16, 18, 20, as well as the client system. The partner-accounts may also store data defining additional authentication protocols that can be used to ensure that server impersonation is precluded. Another use of the partner-accounts is to provide storage for mapping tables for converting between well-known data codings, as used by the information server system 22, and any alternate coding set used by a particular partner site. Other information, such as the identification of a different URL to be used for returning user information or particular requirements of a particular partner site server, can also be stored in individual partner accounts.

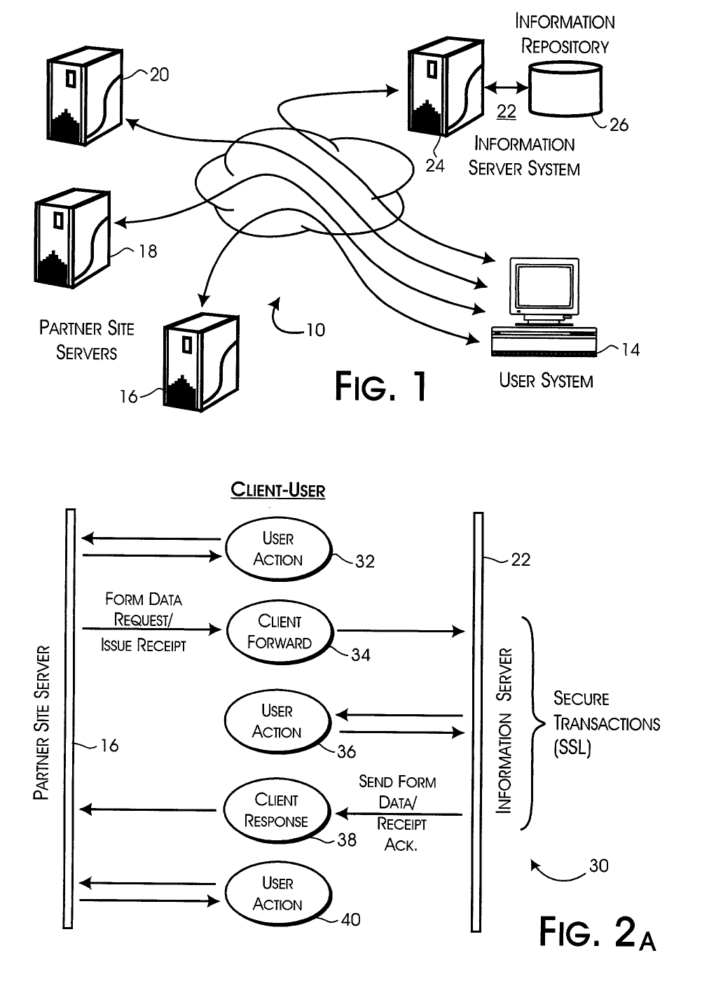

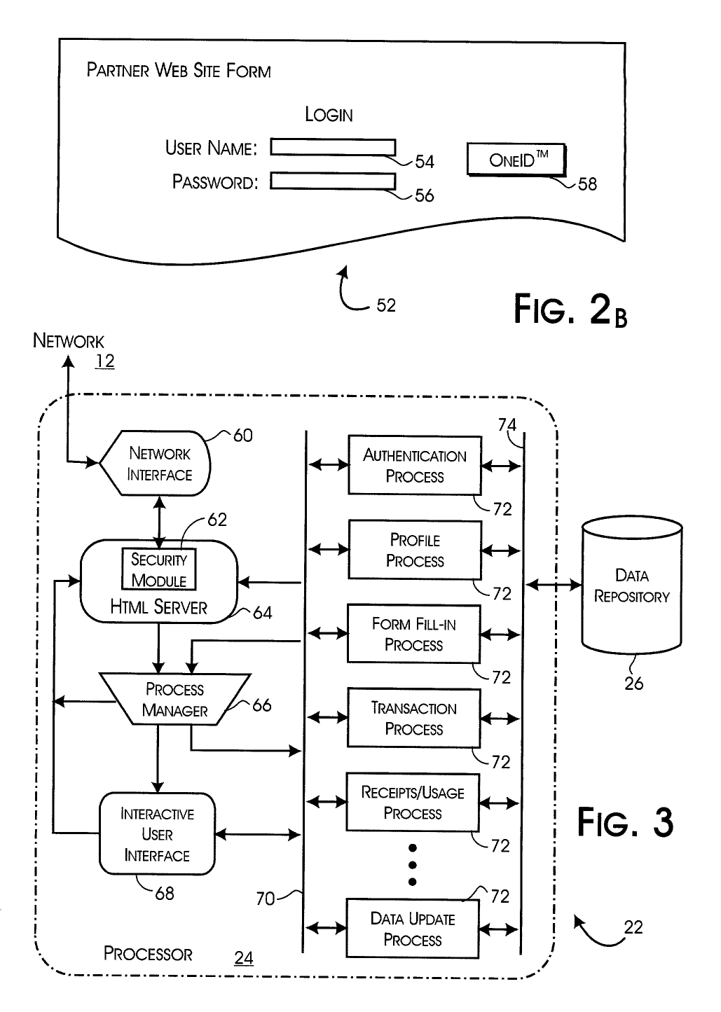

A preferred transactional implementation of the process of the present invention is shown in FIGS. 2A and 2B. The process flow 30 preferably starts with user actions 32, typically Web navigational transactions with some partner site server 16, that results in the user being presented with a form 52 to be completed 54, 56. This form includes the user-interface control 58, hereinafter referred to as the OneID™ button, which is coded with an HTTP Get command for issuance to the URL of the information server system 22, all provided in accordance with the present invention. The HTTP Get command also preferably includes the partner-identifier and one or more identifiers that identify or represent the confidential user-information requested by the partner site server 16. Since the information server system 22 is known to the partner site server 16, the target URL of the information server system 22 can be pre-emptively specified with respect to a particular Get command. Conversely, the partner site URL is either also coded into the Get command or available by lookup by the information server system 22.

When the user selects the user-interface control 58, the HTTP Get command is finally prepared and issued by the client computer system 14, in effect, on behalf of the partner site server 16. This final preparation include incorporation of client system specific data, such as transaction specific identifiers and values, to be included in the Get command. The issuance of the Get command by the client system 14, as opposed to the partner site server, allows information from the client system 14 to be included independent and unseen by the partner site server 16. The issuance of the Get command allows cookies and potentially other data from the client computer system 14 to be passed on to the information server system 22 as part of or associated with the Get command.

The issuance of the HTTP Get command and included information is preferably performed using a secure protocol, such as provided by a secure transactions layer, such as the Secure Sockets Layer (SSL). Use of the secure protocol is preferably maintained as between the partner-site server 16, client system 14, and information server system 22 until a response to the issued request is eventually returned to the partner-site server 16. Preferably, the information server system 22 requires secure transactions between the client system 14 and the information server system 22 whenever confidential user-information is being manipulated.

The client system 14 participates substantively in each communication transaction involving the information server system 22 and any of the partner site servers 16, 18, 20. With each data transaction, the client system 14 provides any applicable cookies stored by the client system to the information server system 22. Preferably, this cookie data includes an identification of the client system 14 and a time signature representing the user of the client system 14 is logged in on the information server system 22. The cookie containing the time signature is preferably stored on the client system 14 as a transient cookie with a short time-to-expiration limit as set by the information server system 22. Each communication between the client system 14 and the information server system 22 may replace or update any or all applicable cookies stored by the client system 14.

Issuance of the HTTP Get command to the information server system 22 gives effect to a top level or overarching transaction between the information server system 22 and a partner site system 16. In response to the receipt of this Get command, the information server system 22 may execute any number of intervening HTTP or other transactions with the client system 36 or simply return the requested data in a Get response to the client system 14 with the partner site system 16 as the effective target. The client transactions preferably include, but are not limited to the set of transactions set forth in Table I.

TABLE I
Client/Information Server System Transactions

Login:
the client time signature cookie has expired or has been removed; a login
screen for the information server system 22 is presented to the user of the
client system 14.
Profile Choice and Confirmation:
no profile has been assigned to this partner server 16 or if assigned, has
not been enabled for autonomous response to the request; a profile choice
or confirmation screen is presented to the user of the client system 14.
Profile and Information Server System Data Update:
the form data requested by the partner server system 16 is not in the
selected profile or is not stored by the information server system 22; the
user is presented with screens to select a different profile, enable the
requested information to be visible in a selected profile, use the existing
available data in responding to the partner server system 16, or to enter the
data into the information server system 22; data that is required by the
partner server system 16 is distinguished from optional data identified in
the request.
Create and Edit Profiles:
the user may create new profiles and revise existing profiles to contain
specific sets of information; new information may also be provided for
storage by the information server system 22 and, thus, made available for
inclusion in any of the profiles; any profile may be marked for auto-
nomous use in response to a request from a particular partner site server
16, marked to require confirmation before responding to a data request by
any particular partner site server 18 or marked to offer the creation or
selection of a profile corresponding the requested data where no profile
has prior assigned to a particular partner site server 20.
Messages and Warnings:
a message or warning is presented to the user where invalid or unknown
data is requested by any partner site server, where the partner site server
account has been closed or terminated, or where the partner site server or
client system login cannot be authenticated.

A response to the form data request by the partner site server 16 is potentially supplemented and approved 36 by the user of the client system 14 through actions taken in intervening HTTP transactions with the information server system 22. Where the user is not already logged in to the information server system 22, an applicable profile requires the confirmation of the release of some confidential user-information, or the responsive information is either not available within the applicable profile or user-account altogether, suitable Web page forms are preferably generated and presented to the user for completion. This new confidential user-information is then stored by the information server system 22 and made available through whatever profiles are designated by the user. Conversely, where the user is logged-in to the information server system 22 and the requested confidential user-information is cleared for automatic release to at least the requesting partner-site, no overt confirming user action 36 is required.

Once the release of confidential user-information is approved, whether directly or indirectly, the applicable profile-delimited responsive data is returned as a response to the initial Get command issued by the client system 14 on behalf of the partner site server 16. The client system response 38 in turn provides form data to the partner site server 16, along with any applicable partner-site cookies. As part of the Get command response processing, the named fields of the form are filled-in. If all of the requested field data identified by the partner site server 16 as required is received, the partner site server 16 may simply proceed and process the form using the provided data. This is preferably the action taken when the form represents a login request for the partner site server 16.

Alternately, the partner site server 16 may autonomously utilize the form with the provided data and await further user actions 40, such as the entry of additional form data or an explicit submission request from the client system 14. Such further form data may be information for required form data fields not provided by the information server system 22 or possibly to encourage the user to complete optional data fields not filled in with data from the information server system 22. In either case, a submission button or the like is conventionally provided by the partner site server 16 on the form page to enable the user to signal that the form has been completed to the extent desired by the user.

The information server system 22 and particularly the server processor 24 is detailed in FIG. 3. The processor 24 preferably includes a network interface 60 that connects with the network 12. A security module 62, preferably implementing the SSL protocol and included as a software component within a HTML, WAP, XML or other Web server 64, operates as an interface to the network interface 60. Information, such as the component parts of the form data received in response to an HTTP Get command, are provided through the Web server 64 to a process manager 66. This process manager 66 may be implemented as a server-side application. In any particular implementation, the process manager 66 preferably operates to stage the series of events needed to respond to whatever Web request that is presented to the network interface 60. Some of these steps may entail the preparation and presentation of information on a virtual or remote interactive user-interface 68 to a user of the client system 14 to, for example, permit additional information to be entered into the corresponding user record as stored in the data repository 26 or present messages and warnings to the client system 14 and potentially to the partner site server 16.

Any data from the user and partner account records, is provided individually or collectively 70 from some number of supporting processes 72_{1-N}. This information may be requested by and returned to the process manager 66 and the virtual interactive user-interface 68. These processes 72_{1-N} variously support the client system 14 and partner site server 16 requests and may include, but are not limited, to the processes identified in Table II.

TABLE II
Information Server System Processes

Authentication Process:
supports the verification that specified client and partner accounts are
active and that any provided IDs, passwords, certificates or tokens are
valid.
Profile Process:
supports the selection of profiles as well as the creation and editing of
profile preferences and contents.
Form Fill-in Process:
supports the identification and selection of data corresponding to the codes
provided with a form data request, including resolving code to available
data ambiguities, from an identified profile.
Transaction Process:
supports the suspension of a current form data request while potentially
multiple user transactions are executed in support of other processes.
Receipts and Receipts-type Data Reporting Process:
supports the collection, updating, and reporting of user receipts, coupons,
registration acknowledgments, and other receipt-type data.
Transaction History Process:
supports the identification and reporting of user and partner detailed
purchase and other activity history records
Data Update Process:
support information server system requests presented a user to obtain
particular data, such as may be needed to suffice a form data request, and
to record the details of individual purchase transactions for both the
partner and client users.

As generally shown, the information provided by the supporting processes 72_{1-N} is returned to the process manager 66 or the virtual interactive user-interface 68, based on the identified source of the information request. The process manager 66 may process this information to determine whether any further steps are necessary before returning data to the client system 14. For example, the form fill-in process 72₃ may indicate either that an assigned profile does not include all or, at least, the required data requested or that the user record simply does not contain some part of the data requested. Thus, depending on the particular response of the form fill-in processor, the process manager 66 may choose to invoke other processes 72_{1-N}, such as the transaction process 72₄, the profile process 72₂, and the data update process 72_{N}.

The data needed to support transactions with the user are prepared by the virtual interactive user-interface 68 and forwarded on to the client system 14 through the HTML server 64. Similarly, the data responsive ultimately to a partner site server 16 request is prepared and returned through the HTML server 64.

The support processes 72_{1-N} may, as appropriate, communicate data to and from the data repository 26. These communications are preferably supported through a software interface 74 to an object or relational database management system that, in turn, manages the reading and writing of account records stored by the data repository 26. Using an object database management system may be preferred.

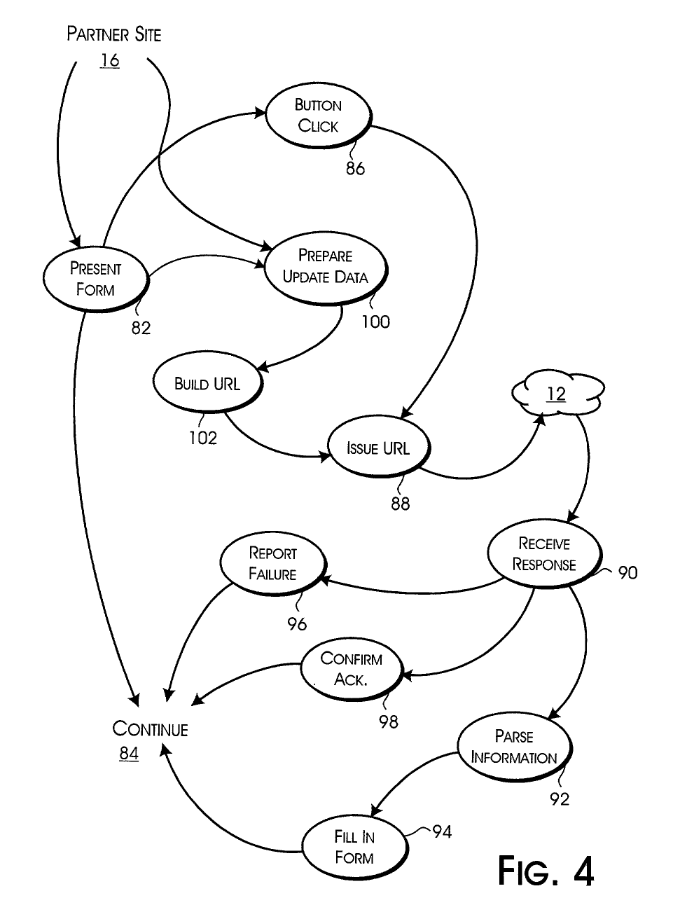

Referring now to FIG. 4, a preferred partner site server 16 process is presented. The partner site server 16, in response to web navigation commands presents 82 a form, such as form 52, to the user of a client system 14. The user may simply choose to complete the form directly and continue 84 with the partner site server 16 controlled process. Alternately, the user may choose to invoke a repository access process by clicking 86 the provided button 58. In response, the client system 14 issues 88 the button embedded predefined coded request for the information needed to complete the form. Preferably, required information is distinguished from optionally entered information in the coded request. This coded request preferably contains a URL containing a Get command and identifications of the source partner site server 16 and target information server system 22. The Get command also preferably contains a reference to a mapping of the named form fields for which information is requested and the corresponding data fields supported by the information server system 22. Preferably, the mapping is predefined and stored, in part, by the information server system 22.

A response to the coded request is preferably received 90 and parsed 92 to recover the coded information returned. This information is then used to fill-in 94 the form presented by the partner site server 16. Additional codings or other information may also be returned to the partner site server 16 to specify whether the filled-in form should be redisplayed to the user and await further user input or be automatically submitted to the partner site server 16 for continued 84 processing.

Where the network transmission of the response is incomplete or invalid, a failure report may be issued 96 to the user and, preferably, to the partner site server 16. The user notification at least allows the user to be aware of the failure. The notification to the partner site server 16 preferably enables continued processing 84 through an error management routine that may simply reissue the coded request to the information server system 22 or present the user with the choice to abort or reinitiate the process of requesting information from the information server system 22.

A partner site server 16 can provide receipt-type data to the information server system 22. While this data may be submitted autonomously by the partner site server 16, preferably a Web page containing the information to be submitted, in effect a pseudo-form page, is presented to the user. Either in response to a button click 86 initiating the submission of the data or a page display trigger, the data is prepared 102 by associating each component of the data with an explicit data field name supported by the information server system 22, or a pseudo-field name that is then mapped to a corresponding data field name. Where the receipt-type data is dynamically generated by the partner site server, the content of the Get command, or alternately a Post command, must be dynamically prepared 100. A URL including the Get command data then built 102 and sent 88. The response received 94 is preferably a confirmation acknowledgment message 98, indicating that the data has been received and appropriately handled by the information server system 22. After receiving an acknowledgment, the partner site server 16 continues 84 typically to interact with the user of the client system 14. Where a negative acknowledgment or some other failure message is received, the failure is reported 96 preferably to the partner site server 16, which can the continue 84 and handle the error condition.

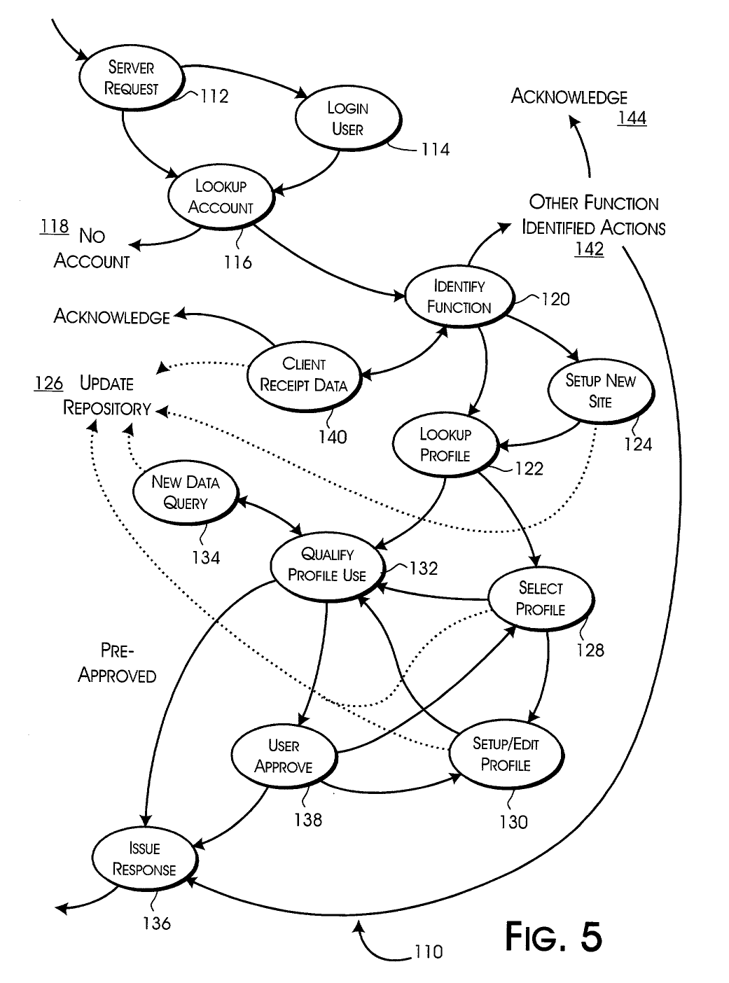

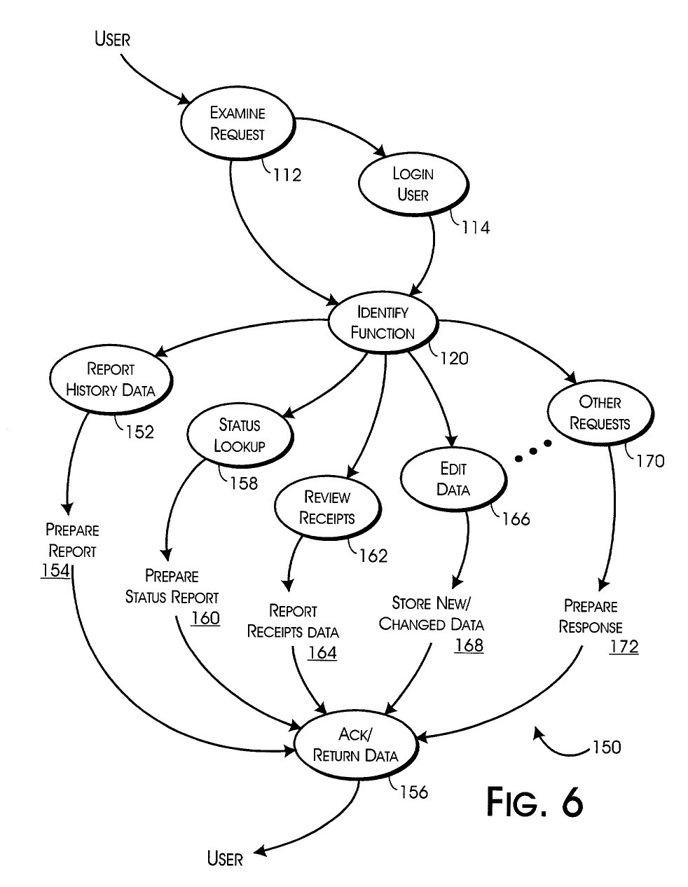

The preferred information server system 22 process is shown in FIG. 5. Inbound requests from a client system 14 are received 112 as information server requests. This request is automatically coupled with a client time-signature cookie, if available. If the signature cookie is not present or has expired, the user is permitted to logon 114. Provided there is a successful login, the data from an expired time signature cookie is replaced by the new login information.

The request is then examined to retrieve the account information, including the partner-identifier, of the partner site server 16. The client-identifier is obtained from the client cookie or newly logged in account. In performing an account lookup 116, if either account is not found or is not active, a failure message 118 is returned by the information server system 22. Where both site accounts are found and are active, a site coded request function is identified 120 from the request. Typically, the site function identifies a specific request for data to fill-in a form. The profiles defined in the user-account, as stored by the data repository 26, are then examined to identify 122 a profile associated specifically or by general criteria with the identified partner site server 16. If such a profile is not found, the user may be prompted to enable setup of a new site 124, producing update data reflecting a change in the associated user account, which is then updated 126 to the data repository 26. Where a new site is setup or where no profile is associated with a prior setup of the site, or where the site-identified profile is set to require a re-selection of the applicable profile, the user is presented with a form-based opportunity to select and apply an existing profile from the user account. Where a profile is selected, the user account is correspondingly updated 126. The user is then permitted to immediately use the selected profile or setup 130 and select a new profile for the identified site. In both instances, the user is preferably also permitted to edit 130 the selected profile.

The selected profile is then qualified, particularly as to whether sufficient information is present in or through the profile to fully respond to the outstanding information request. A new data query, if needed, is presented 134 to the user to enable profile access to data stored at large in the user account and to obtain information identified in the information request but not present in the user account. In the former case, the selected profile is updated 126 to indicate that additional information is at least logically included in the selected profile. In the later case, the new information entered is updated 126 to the user account and again the selected profile is updated 126 to indicate that additional information is at least logically included in the selected profile.

The selected profile is also qualified 132 as to whether use of the profile is pre-approved for automatic response or requires user approval prior to a response being issued back to the partner site server 16. Where use of the profile is pre-approved, the request responsive data is collected from the selected profile, coded into Get response and issued 136 to the client system 14 for further return to the partner site server 16. Where user approval 138 is required, the user is presented with a confirmation form, preferably including an identification of the current information to be submitted to the partner site server 16. The user may then approve issuance 136 of the response, select another profile 128, create a new profile 130, and edit 130 the selected profile.

Another partner site function is the submission, by a partner site server 16, of receipt-type data, which may include data describing a single purchase transaction, a historical set of transactions, and other activity data for storage in the user account. Such activity data is recovered 140 from the partner site server 16 request. The data is updated 126 to the data repository 26. An acknowledgment of the successful updating of the user account data may optionally be returned to the partner site server 16. In similar fashion, other function identified actions 142 may be recognized 120 and suitable responses prepared. These responses may be presented as acknowledgments 144 or coded responses 136 containing data obtained from the data repository 26.

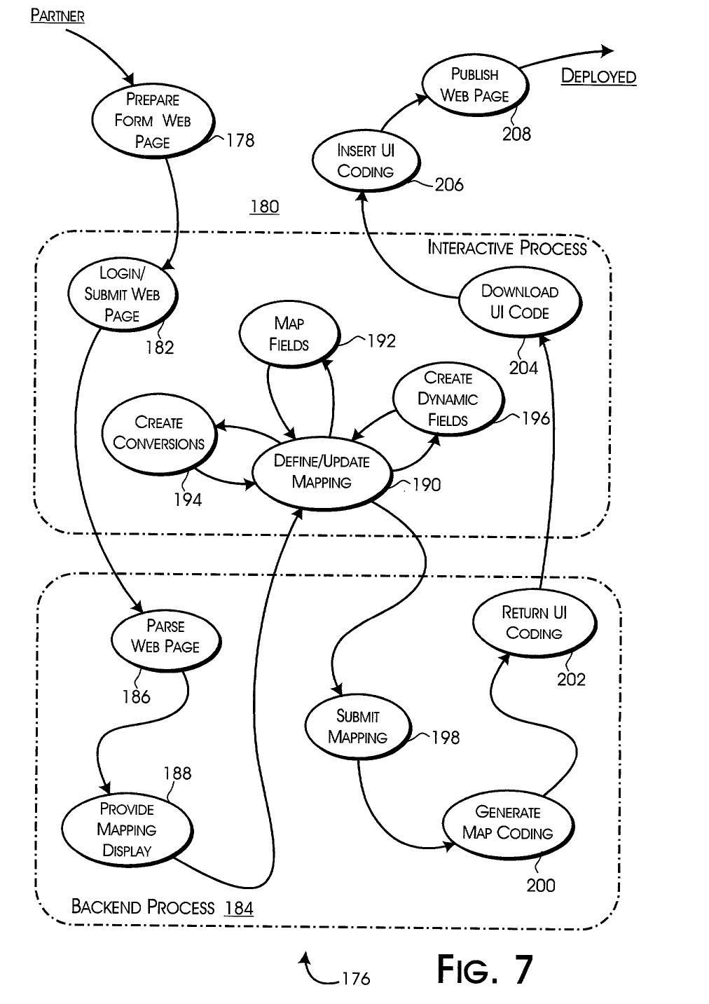

FIG. 6 shows a preferred process flow 150 for user interactions directly with the information server system 22 from the client system 14. User interactions are preferably supported through a public Web site (not shown) and, in general, presented as one or more Web pages containing the selections available to the user and fields that enable user entry and editing of the data stored in an account record. This Web site is preferably hosted by or on behalf of the information server system 22. The Web site may thus be considered part of the information server system 22.

When a selection or entry is submitted by the user, the resulting URL packaged request is submitted, received and examined 112. If the accompanying time signature cookie is present and not expired, the request embedded within the received URL is further examined to recover the identified function 120 selected by the user. Alternately, where the time signature cookie has expired, the information server system 22 presents the user with a login screen 114 prior to further examination of the received request.

Any number of different function requests can be submitted to the information server system 22. Choice of a specific function may be by a user through a subsequent, more detailed selection list presented as a secure Web page form to the user. As represented in FIG. 6, a report of partner transaction data and other historical information may be requested. A report is prepared 154 and returned 156 to the user preferably as another Web page. Similarly, a function requesting a status check 158 of pending purchases results ultimately in the preparation 160 of a corresponding status report and return 156 of the status report as a Web page. Receipt-type data can also be reviewed 162 and reported 164 to the user.

The information system server 22 preferably responds to a function request ultimately specifying the modification of some account record data by presenting a corresponding Web page to permit entry of the modifications. Such modification may include the editing 166 of profiles, the informational contents of the account data, the specific and general association of profiles with partner sites, and various user account and profile preferences. The modified data, when submitted back 168 to the information server system 22, is stored in the user account. An acknowledgment of the secure receipt and storage of the data may then be returned 156 by the information server system 22. Alternately, a confirmation Web page may be presented to allow the user to verify the data before being committed to the user account within the data repository 26.

Other operations on the user account can be similarly provided by pre-establishing an identifiable 120 request-type. Execution of the corresponding function can then be performed by the information server system to return 156 an appropriate response to the user.

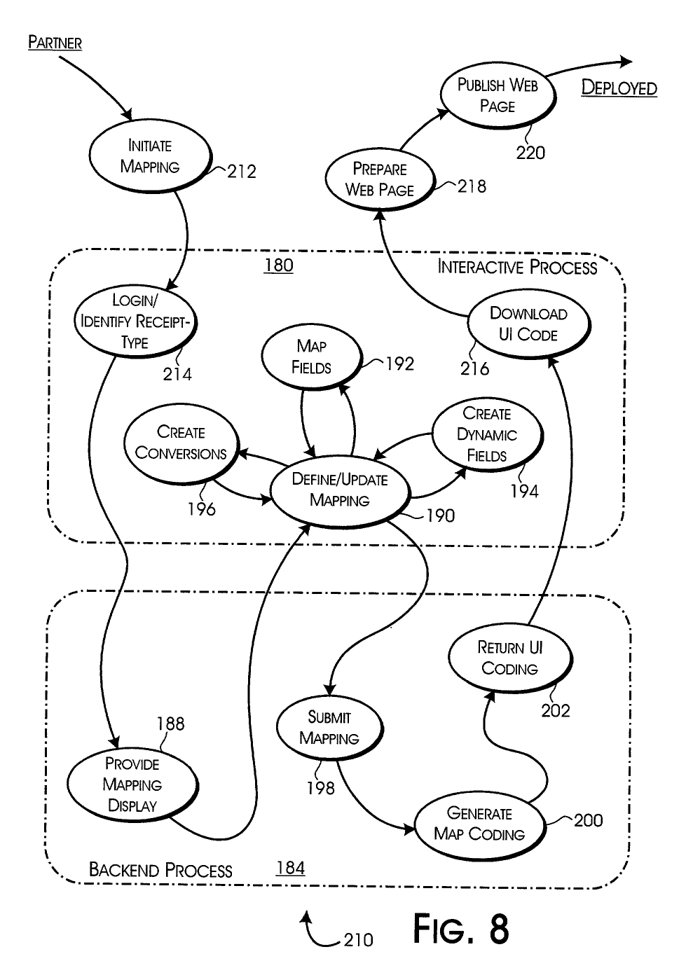

The preferred process 176 of integrating the information server system 22, in accordance with the present invention, with the Web page forms of a partner site 16 is shown in FIG. 7. In order to ease and place a minimum burden on the development and maintenance of partner site Web page forms, the preferred process is implemented as a post-processing step relative to the design and development 178 of a Web page form. The post-processing step begins with the submission of the Web page form to a software mapping tool hosted, directly or indirectly by the information server system 22. In order to submit the Web page form, the developer utilizes an interactive process 180 to receive a login form. The developer is preferably required to login to the partner site account and request the submission of the Web page form 182. The submission process is carried out by uploading the Web page form code through a form provided by the information server system 22. The upload may be specified by the developer providing a URL to the form page and initiated by a button click leading to an activity data transfer of the Web page code directly to the information server system 22. Alternate manners of submitting a Web page form, such as through pasting, can be supported.

When received, the Web page form code is passed to a backend process 184 to be parsed 186. This parsing operates to identify the names of the form fields embedded in the Web page form. Based on the names parsed from the form, a mapping display process is then executed to define, to a reasonable extent, a likely mapping of the form field names to the names of the data fields defined for the data repository 26. The resulting mapping table is then passed to the interactive process 180 for display 190 to the Web page developer. The displayed form allows the developer to correct and complete the association of form field names to data field names. While a form field name such as “First Name” could be autonomously mapped to a likely corresponding data field named “$o_firstname$,” a form field name “PrimaryN” is unlikely to be correctly mapped to “$o_firstname$.” The mapping form preferably allows form field names to be associated with data field names using a simple clickable interface.

Another mapping issue handled by the mapping tool of the present invention involves specifying value format conversions. Preferably, the mapping form allows a Web page form developer to construct value format conversions using parsing, logical combination, concatenation, translation, and other functions and operators. Conversions defined using these functions and operators are applied against identified data fields of the data repository to create a value format conversion appropriate for returning data from the information server system 22 in a manner that matches the desired value format of a Web page form field.

For example, where a single form field requires a full name, a format conversion is required where the data repository separately carries first, middle, and last names. For a form field name of “p_name” and data field names “$o_firstname$,” “$o_middlename$,” “$o_lastname$,” a value format conversion can be constructed using concatenation as:

p_name=$o_firstname$+$o_middlename$+$o_lastname$.

Format conversions are also required where, for example, a date must be provided in a locale specific format or credit card numbers must be provided with particular punctuation or broken-up into four component number fields for entry. To provide punctuation, specifically using a colon in this example, a value format conversion for a form field named p_creditcard number can be constructed using parsing and concatenation:

$oa_1$=$subst(o_ccnumber, 1, 4)$;

$oa_2$=$subst(o_ccnumber, 5, 8)$;

$oa_3$=$subst(o_ccnumber, 9, 12)$;

$oa_4$=$subst(o_ccnumber, 13, 16)$;

p_creditcardnum=$oa_1$%3A$oa_2$%3A$oa_3$%3A$oa_4$;

where %3A is the encoded format of “:”.

Other instances and types of format conversions can be numerous. Since the value format conversion is performed by the information server system 22, a flexible and, as needed, large library of conversion functions and operators may be maintained universally for use by Web page developers.

Predefined, or aliased, conversions are preferably also supported by the mapping tool. In the preferred embodiments of the present invention a date data field is aliased to a number of locale specific date data fields. Referencing the data field name of an aliased date data field is recognized by the information server system 22 as requiring a corresponding conversion. Thus for a form field name “p_date,” a mapping of “p_date=$o_dateEPlocale$” is logically expanded and executed as:

p_date=$european_date(o_date)$;

where the pre-defined function “european_date” provides the appropriate conversion. Thus, many common conversions may be easily represented as merely alternative data repository data field names. Such pre-supplied conversion function aliases, combined with the potential of allowing a developer to store custom conversion functions in the partner site account, greatly eases the process of defining the form field name mapping.

In connection with performing field name mapping, the present invention permits the Web page form developer to define and name custom or “dynamic” data fields 196 and then map form field names to those data fields. This allows the Web page developer to expand the base of information carried by the information server system 22 on behalf of the partner site server 16. When a user encounters a Web page form that includes a dynamic data field, the information server system 22 will present the field to the user for completion in the same manner that predefined data repository 26 fields are presented to request data entry or prompted for inclusion in the current applicable profile. Where data is provided to the information server system 22 for a custom data field, the data object representing the profile is preferably extended to provide storage for the entered data. Subsequently, references from the partner site server 16 to the dynamic data field name will return the corresponding stored data. As the creation and subsequent management of the dynamically created data fields is handled for the partner site server 16, the only significant requirement placed on the Web page developer is to associate their assigned data field name with a consistent definition or understanding of what the stored data represents. Since this definition is specific to the partner site account, the developer is well capable of maintaining such a definition.

Once the mapping 190 of a Web page form is completed, the developer submits the mapping 198 for generation 200 of a map coding block. Preferably, this map coding block includes a structured set of mapping statements, such as those illustrated above. In a preferred embodiment of the present invention, a generated map coding block will be of the general form:

| | |
|---|---|
| http://www.oneid.com/site/partner.jsp? | // target URL |
| method=post | // transport method |
| &sid=230776 | // partner-identifier |
| &action=form_encode(formpage_URL) | // source URL |
| &p_map=form_encode( \ | |

p_date=$o_dateEPlocale$& \
p_name=$o_firstname$+$o_middlename$+$o_lastname$& \
$oa_1$=$subst(o_ccnumber, 1,4)$& \
$oa_2$=$subst(o_ccnumber, 5,8)$& \
$oa_3$=$subst(o_ccnumber, 9,12)$& \
$oa_4$=$subst(o_ccnumber, 13, 16)$& \
p_creditcardnum=$oa_1$%3A$oa_2$%3A$oa_3$%3A$oa_4$&\
p_fieldname1=lib_conversionX($o_datafieldnameA$)

)

The generated map coding block is then wrapped 202 preferably with the HTML coding for a simple Ul button 58. The resulting UI code, including the map coding block is then presented to the developer for download 204. In connection with the preferred embodiments of the present invention, the developer will then need only to insert 206 the downloaded UI code in the previously prepared form Web page in a manner that visually places the UI button 58 at an appropriate location on the Web page form. The Web page form is then ready to publish 208 using any conventional Web page deployment tool.

An alternate process 210 of using the software mapping tool is shown in FIG. 8. The process 210 may be used where the Web page developer wishes to use the mapping tool before preparation of a Web page form 178. The process 210 is perhaps more typically used where the developer is preparing a receipts-type data display Web page and wishes to submit the data to the information server system 22. In either case, the mapping tool is used as a pre-processing-type step to generate UI code that can be included on a Web page.

Similar to the process 176, the developer initiates 212 the mapping process 210 by logging in and setting 214 the tool to a pre-processing mode. A comprehensive mapping table is prepared. The mapping display 190 is then presented to the developer. While place-holder field names may be defined and used to map against the data repository data fields, the developer may choose to directly use the data repository data field names. These place-holder field names are used as pseudo-filed names, since a dynamically generated receipts-type Web page will not include any form fields. These pseudo-field names are therefore assigned by the developer to different data elements presented on the receipts-type Web page as part of the mapping 192. The pseudo-field names may be of particular use where the presented data must be converted to a value format defined by a data repository data field, generally as described above. Alternately, use of data repository data field alias names may be sufficient to implicitly convert the developer chosen format of the receipts-type data to a value format appropriate for storage in the data repository 26.

Mapping 192, value format data conversion 196, as well as the creation of dynamic fields for storing unique receipts related data, such as a shirt pattern type, size, or other information descriptive of the receipted transaction, are all available to the developer through the mapping display 190. Once the mapping 190 is complete, the mapping is submitted 198, a map coding block generated 200, and preferably wrapped with the HTML coding for a simple UI button 58. The resulting UI code is then presented for downloading 216 to the developer. Once retrieved, the UI code can then be used in the preparation of the Web page form or receipts-type data page 218 by the developer. When completed, the Web page can then be published using a conventional deployment tool.

Thus, a user identification system, including the capability maintain and securely supply user data to third-party sites, has been described. While the present invention has been described particularly with reference to HTML and Web page based transactions, the present invention is equally applicable to e-commerce sites utilizing other and additional communications and data sharing protocols, including eHTML, XML, SGML, and wireless systems. The present invention is also applicable to any site that presents a form for user data fill-in.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A repository server system supporting a one-click retrieval of user data over a communications network in fulfillment of the data requirements of a Web page form served to a user computer system by a Web page server, wherein said repository server system includes a data store that stores user data, wherein said repository server system provides said Web page form with a clickable user interface control as served to said user computer system, said control including a user data request, issuable by said user computer system and corresponding to said Web page form, wherein said repository server system is responsive to said user data request to provide a user data response, corresponding to said user data request, to said user computer system.

2. The repository server system of claim 1 wherein said user data request identifies a mapping between data stored by said data store and said Web page form.

3. The repository server system of claim 2 wherein said mapping is comprehensive relative to said user data request.

4. The repository server system of claim 3 wherein the data requirements of said Web page form are defined independent of the form of said user data as stored by said repository server system and wherein said repository server system provides said user data in conformance with said user data request.

5. A method of securely submitting confidential user information from a repository server to a client server over a communications network, said method comprising the steps of:
a) encoding a specification of client requested user data in a Web page served, by the request of a user, from a client server to a user computer system, wherein said specification defines a non-identity named data correspondence between said client requested user data and user data stored by said repository server;
b) enabling said user to issue, by a single click, a data request including said specification to said repository server; and
c) providing a data response from said repository server providing user data consistent with said specification.

6. The method of claim 5 wherein said client requested data is defined by said client server and wherein said method further comprises the step of determining a named data correspondence between user data defined by said client server and user data stored by said repository server.

7. The method of claim 6 wherein said step of determining includes identifying data conversions that implement said non-identity named data correspondence between said client requested user data and user data stored by said repository server.

8. The method of claim 7 wherein data conversions performed to implement said non-identity named data correspondence in response to receipt of said data request by said repository server are performed autonomously, whereby there is an identity correspondence between said single click and provision of said data response.

9. The method of claim 8 wherein said specification includes an identification of said client server and wherein said repository server provides for the autonomous authentication of said client server and said user with respect to said specification as issued by said user computer system.

10. A system enabling a one-click logon of a user onto a partner site where said user has an account with a repository server system, said system comprising a repository server coupleable to a communications network to receive a first coded message from a user site, wherein said coded message includes a partner site identification provided from said partner site, a user account identification, and a mapped identification of partner-site fields to be filled, said repository server providing for the verification of said partner site identification and said user account identification, and wherein said repository server selectively generates a second coded message directed to said partner-site containing login information appropriate to complete the logon of said user onto said partner site.

11. The system of claim 11 wherein said repository server operates to validate said user account identification against information held by said repository server specific to said user and said partner site identification against information held by said repository server specific to said partner site and wherein said repository server generates said second coded message based on information held in said user account that correlates to said partner site.

12. A method of enabling the secure submission of confidential user information to a partner site computer system comprising the steps of:
a) first providing, in response to the activation of a control associated with a Web page served to a user computer system provided by said partner site computer system, a coded request message for confidential information to a predefined repository server system; and
b) second providing, in response to receipt of said coded request message, a response message from said predefined repository server system containing a release set of confidential user information to said user computer system.

13. The method of claim 12 wherein said control is activatable by a predetermined action performed by a user of said user computer system.

14. The method of claim 13 wherein said predetermined action is a single click by said user on said control.

15. The method of claim 13 wherein said step of second providing includes the step of authenticating said partner site system and said user computer system with respect to said coded request message.

16. A method supporting the submission of user information to a client computer system over communications network comprising the steps of:
a) providing, from a client computer system to a user computer system, a coded request for first user data associated with a Web page;
b) forwarding said coded request, selectively based on action performed on said user computer system relative to said Web page, to a data repository system;
c) receiving, by said user computer system, a coded response from said data repository system including second user data; and
d) providing, by said user computer system, said second user data to said client computer system relative to said Web page.

17. The method of claim 16 wherein said coded request is associated with a coded control provided on said Web page and wherein said action is an operation executed on said user computer system on said coded control.

18. The method of claim 17 wherein said coded control is a user interface control provided on said Web page and wherein said action is a single click by a user of said user computer system on said user interface control.

19. The method of claim 18 wherein said coded request is constructed with an identification of said data repository system, said client computer system, and said Web page to securely identify said client computer system and to identify said first user data to said data repository system.

20. A method supporting the autonomous submission of user data to a client computer system over a communications network, said method comprising the steps of:
a) issuing, in response to a single user click on a user interface control provided on a Web page served from a client computer system, a user data request determined by said client computer system specific to said Web page from said user computer system to a data repository system over said communications network; and
b) returning, subject to the secure identification of said client computer system and said user computer system relative to said user data request, user data corresponding to said user data request.

21. The method of claim 20 wherein said step of returning is further subject to the limitations of the data stored by said data repository system.

22. The method of claim 21 further comprising the steps of:
a) requesting by said data repository system, prior to said step of returning, additional data from said user computer system; and
b) storing said additional data by said data repository system.

23. The method of claim 22 wherein said step of requesting occurs subsequent to said step of issuing and wherein said additional data is responsive to a portion of said user data request.

24. The method of claim 23 wherein said additional data includes data signifying an approval to provide user data to said client computer system.
